(19) United States
(12) Patent Application Publication
(10) Pub. No.: US 2024/0219346 A1
(43) Pub. Date: Jul. 4, 2024

(54) DETECTOR

(71) Applicant: Sharp Display Technology Corporation, Kameyama City (JP)

(72) Inventors: Yuuki OOTSUKA, Kameyama City (JP); Tomohiro Kosaka, Kameyama City (JP); Tomoko Teranishi, Kameyama City (JP); Kei Ikuta, Kameyama City (JP); Reshan Maduka Abeysinghe, Kameyama City (JP); Makiko Matsumoto, Kameyama City (JP)

(21) Appl. No.: 18/522,651

(22) Filed: Nov. 29, 2023

(30) Foreign Application Priority Data
Dec. 28, 2022 (JP) 2022-211324

(51) Int. Cl. G01N 27/624

(52) U.S. Cl. CPC G01N 27/624

(57) ABSTRACT

A detector includes a first substrate, a second substrate, a first electrode, a second electrode that faces the first electrode with a gap therebetween and forms a flow path for charged particles, a third electrode that is provided on a downstream side of the flow path relative to the first electrode or the second electrode and collects the charged particles, a fourth electrode that is provided on an upstream side of the flow path relative to the first electrode, and a fifth electrode that is provided on the upstream side relative to the second electrode and generates corona discharge between the fifth electrode and the fourth electrode. The fourth electrode and the fifth electrode are disposed to be displaced relative to each other on the upstream side and the downstream side of the flow path.

### BACKGROUND

### 1. Field

The technology disclosed in the present specification relates to a detector.

### 2. Description of the Related Art

Known detectors that separate and detect ions (charged particles) by ion mobility are described in Japanese Unexamined Patent Application Publication No. 2008-77981 (Patent Document 1), Japanese Unexamined Patent Application Publication (Translation of PCT Application) No. 2004-529467 (Patent Document 2), and Japanese Unexamined Patent Application Publication (Translation of PCT Application) No. 2008-528993 (Patent Document 3). Patent Document 1 describes an ionizer as a detector. The ionizer described in Patent Document 1 includes a body, a soft X-ray tube, and electrodes. The body has an ionization chamber that extends in a predetermined axial direction and ionizes sample molecules, an inlet through which the sample molecules are introduced into the ionization chamber, and an outlet through which sample molecule ions are discharged. The soft X-ray tube has an electron source and a target portion that receives electrons from the electron source and generates soft X-rays. The electrodes are provided respectively at one end side and the other end side of the ionization chamber. The soft X-ray emission-axis direction of the soft X-ray tube intersects the predetermined axial direction. An electrode provided in the target portion and one of the electrodes are short-circuited to each other. The central axis direction of the inlet intersects the soft X-ray emission-axis direction.

Patent Document 2 describes a chemical sensor system as a detector. The chemical sensor system described in Patent Document 2 includes a sample preparation section that ionizes a sample, a filter section that filters ions generated by the sample preparation section, and an output section that detects ions that have passed through the filter section. The sample is ionized as a voltage difference is generated between an electrospray head and an attraction electrode included in the liquid sample preparation section.

Patent Document 3 describes an ion mobility spectrometer as a detector. The ion mobility spectrometer described in Patent Document 3 has a corona discharge needle that ionizes a sample of a gas or a vapor. A gate is opened or closed to allow or prohibit introduction of ions, generated by corona discharge, into a drift chamber. The operations of the corona discharge needle and the gate are controlled so that, by opening the gate during corona discharge that is performed at least twice, ions generated by the latest discharge and having a high movement speed are passed together with ions generated by the previous discharge and having a low movement speed.

Patent Document 1 discloses a technology for ionizing a sample by using soft X-rays. Patent Document 2 discloses a technology for ionizing a sample by using an electrospray method. Patent Document 3 discloses a technology for ionizing a sample by corona discharge. Among these, in the ion mobility spectrometer described in Patent Document 3, a corona needle made of a metal protrudes coaxially along a housing having electrically insulating properties, and a pointed end of the corona needle is positioned in a tube made of brass or nickel. A high voltage of about 5 kV, which is sufficient for generating corona discharge, is applied between the corona needle and the tube.

Some mobility analyzers using the field asymmetric ion mobility spectrometry (FAIMS) have a configuration such that a pair of parallel-plate filter electrodes and the like are provided on a pair of substrates that face each other. In some cases, electrodes for generating corona discharge are provided on the pair of substrates so that an ionization source that ionizes a sample by corona discharge can be contained in a mobility analyzer. In such cases, it is difficult to make space for generating corona discharge, because the distance between the pair of substrates is at most several hundred micrometers. Therefore, a problem in that a sufficient amount of ions cannot be generated may occur.

It is desirable to provide a technology that enables a sufficiently large amount of ions to be generated.

### SUMMARY

According to an aspect of the disclosure, there is provided a detector including: a first substrate having a first main surface; a second substrate having a second main surface that faces the first main surface of the first substrate with a gap therebetween; a first electrode that is provided on the first main surface of the first substrate; a second electrode that is provided on the second main surface of the second substrate, that faces the first electrode with a gap therebetween, and that forms a flow path for charged particles, which are to be detected, between the second electrode and the first electrode; a third electrode that is provided on the first main surface of the first substrate or the second main surface of the second substrate, that is disposed on a downstream side of the flow path relative to the first electrode or the second electrode, and that collects the charged particles; a fourth electrode that is provided on the first main surface of the first substrate and that is disposed on an upstream side of the flow path relative to the first electrode; and a fifth electrode that is provided on the second main surface of the second substrate, that is disposed on the upstream side of the flow path relative to the second electrode, and that generates corona discharge between the fifth electrode and the fourth electrode. The fourth electrode and the fifth electrode are disposed to be displaced relative to each other on the upstream side and the downstream side of the flow path.

### BRIEF DESCRIPTION OF THE DRAWINGS

FIG. 1 is a schematic view illustrating the configuration of a mobility analyzer including a detection cell according to a first embodiment;

FIG. 2 is a block diagram of a controller included in the mobility analyzer according to the first embodiment;

FIG. 3 is a map graph representing a FAIMS spectrum obtained by the mobility analyzer according to the first embodiment;

FIG. 4 is a plan view of a first substrate included in the detection cell according to the first embodiment;

FIG. 5 is a plan view of a second substrate included in the detection cell according to the first embodiment;

FIG. 6 is a plan view illustrating, in an overlapping manner, the planar configuration of the second substrate and the planar configuration of the first substrate according to the first embodiment;

FIG. 7 is a plan view illustrating, in an overlapping manner, the planar configuration of a second substrate and the planar configuration of a first substrate according to a second embodiment;

FIG. 8 is a plan view illustrating, in an overlapping manner, the planar configuration of a second substrate and the planar configuration of a first substrate according to a third embodiment; and

FIG. 9 is a schematic view illustrating the configuration of a mobility analyzer including a detection cell according to a fourth embodiment.

### DESCRIPTION OF THE EMBODIMENTS

### First Embodiment

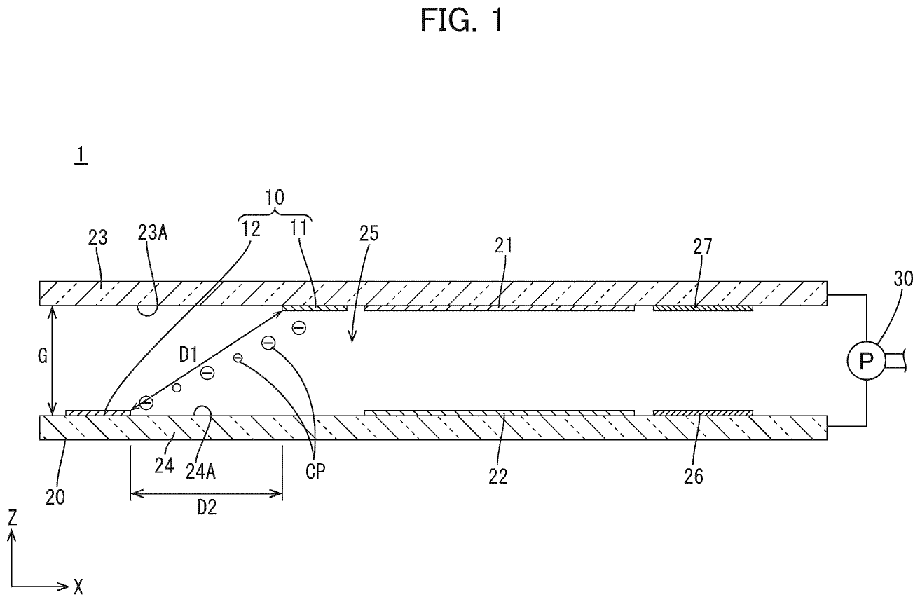

Referring to FIGS. 1 to 6, a first embodiment will be described. In the present embodiment, a mobility analyzer 1 using the electric field asymmetric ion mobility spectrometry (FAIMS) (hereafter, simply referred to as “analyzer”) will be described. The X axis, the Y axis, and the Z axis are shown in a part of each figure, and each axis direction is illustrated to be a direction shown in each figure.

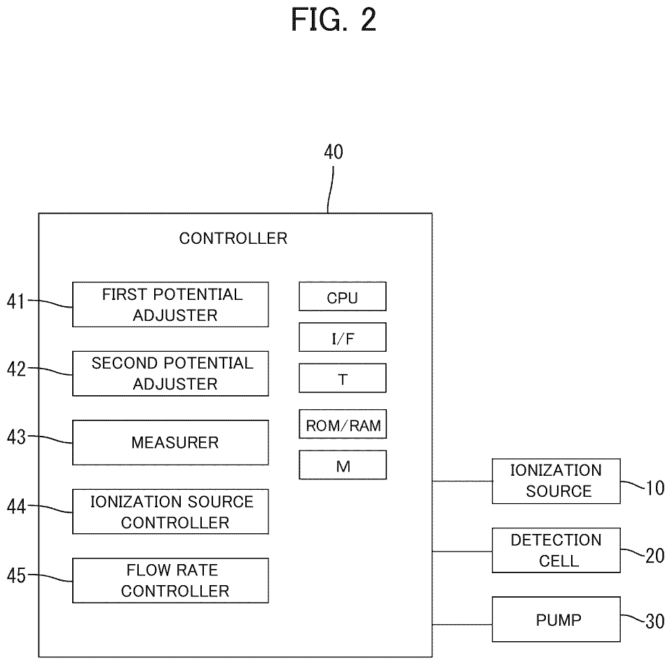

As illustrated in FIG. 1, the analyzer 1 includes a detection cell (detector) 20, a pump 30 (an example of an air-blowing device), and a controller 40 (see FIG. 2). Hereafter, each element will be described.

The detection cell 20 is an element that separates (filters) charged particles (ions) CP based on a difference in mobility and detects charged particles CP having a predetermined mobility. The detection cell 20 includes a first electrode 21, a second electrode 22, a first substrate 23 (an example of a supporter), a second substrate 24 (an example of a supporter), a detection electrode (third electrode) 26, and a deflection electrode 27. In addition, the detection cell 20 according to the present embodiment contains an ionization source 10 for ionizing atoms and molecules of a chemical compound (sample) to be analyzed to generate the charged particles CP. These elements of the detection cell 20 may be disposed in a chamber. The ionization source 10 will be described below in detail.

The first electrode 21 and the second electrode 22 constitute a pair of parallel-plate filter electrodes by being disposed to face each other. The first electrode 21 and the second electrode 22 have main surfaces that face each other and are parallel to each other. There is a predetermined gap between the first electrode 21 and the second electrode 22. A flow path 25 for the charged particles CP is formed between the first electrode 21 and the second electrode 22. Hereafter, a direction in which the charged particles CP flow through the flow path 25 will be referred to as “first direction”. It can be said that the first direction is the flow direction of the charged particles CP. The first direction coincides with the X-axis direction in each figure. Hereafter, a direction that is along the main surfaces of the first electrode 21 and the second electrode 22 and that is perpendicular to (intersects) the first direction will be referred to as “second direction”. The second direction coincides with the Y-axis direction in each figure. The flow path 25 includes an ion separation space (draft space). The first electrode 21 and the second electrode 22 in the present example are respectively disposed on the facing surfaces of the first substrate 23 and the second substrate 24 described below. Hereafter, a direction from the first electrode 21 toward the second electrode 22 will be referred to as “third direction”. The third direction is the normal direction of the facing surfaces (main surfaces) of the first electrode 21 and the second electrode 22. The third direction coincides with the Z-axis direction in each figure.

The shape, the size, and the like of each of the first electrode 21 and the second electrode 22 are not particularly limited. The first electrode 21 and the second electrode 22 of the present example each have a rectangular shape that is slightly elongated in the X-axis direction (first direction). The dimension of each of the first electrode 21 and the second electrode 22 in the X-axis direction may be, for example, about 0.1 cm or greater (for example, 1 cm or greater) and about 50 cm or less (for example, 10 cm or less), although this is not a limitation. The thicknesses of the first electrode 21 and the second electrode 22 are not particularly limited, and may be independently and appropriately set in the range of about 50 nm or greater to about 1 μm or less. The thickness of each of the first electrode 21 and the second electrode 22 is typically 600 nm or less, for example, 400 nm or less, and typically 100 nm or greater, for example, 200 nm or greater.

A filter gap G, which is the gap between the first electrode 21 and the second electrode 22, is not strictly limited. The filter gap G may be narrow, because, in this case, it is possible to effectively increase the strength of an electric field to be formed in the ion separation space (corresponding to the dispersion voltage described below). However, there is a dilemma between the narrowness of the filter gap G and the likelihood of generation of electric discharge or an eddy current of airflow between the first electrode 21 and the second electrode 22. Accordingly, the filter gap G may be set, for example, in the range of several tens of micrometers or greater to several hundreds of micrometers or less. By doing so, an eddy current becomes unlikely to be generated and a laminar flow becomes likely to be generated in the flow path 25 of the detection cell 20.

The material of the first electrode 21 and the second electrode 22 is not particularly limited. The material of the first electrode 21 and the second electrode 22 may be any electroconductive material that can generate an electric field described below between the electrodes 21 and 22, and may be any of a metal material, an inorganic electroconductive material, and an organic electroconductive material. If it is conceivable that a sample and the ions thereof, which are to be detected, are corrosive to metals, either of an inorganic electroconductive material and an organic electroconductive material may be used as the electroconductive material of surfaces of the first electrode 21 and the second electrode 22. A metal material of the first electrode 21 and the second electrode 22 is not particularly limited. For example, when the first electrode 21 and the second electrode 22 are to be formed by using a lithography technology using an ArF excimer laser, a metal selected from highly-electroconductive metals such as gold (Au), copper (Cu), titanium (Ti), aluminum (Al), chrome (Cr), molybdenum (Mo), tantalum (Ta), and tungsten (W), an alloy of any of these metal, or an alloy of two or more of these metals may be used. A structure in which layers of these metal are stacked in the form of W/Ta, Ti/Al, Ti/Al/Ti, Cu/Ti, or the like in order from the upper-layer side, may be used to improve physical properties such as adhesion to a base layer (typically, the first substrate 23 or the second substrate 24). Examples of an inorganic electroconductive material include indium tin oxide (ITO), indium-zinc-oxide (IZO), indium-gallium-zinc-oxide (IGZO), and ZnO. Examples of an organic electroconductive material include polyacetylene and polythiophene. The first electrode 21 and the second electrode 22 may be formed by stacking two or more layers of a metal material, an inorganic electroconductive material, and an organic electroconductive material.

The first substrate 23 and the second substrate 24 are disposed in such a way that the main surfaces thereof face each other. The first substrate 23 is an element that supports the first electrode 21 and the deflection electrode 27. Among a pair of mains surfaces of the first substrate 23, a main surface that faces the second substrate 24 is a first main surface 23A. The first electrode 21 and the deflection electrode 27 are provided on the first main surface 23A of the first substrate 23. The first substrate 23 has the first electrode 21 and the deflection electrode 27 at positions that are separated in the X-axis direction. The second substrate 24 is an element that supports the second electrode 22 and the detection electrode 26. Among a pair of mains surfaces of the second substrate 24, a main surface that faces the first substrate 23 is a second main surface 24A. The second electrode 22 and the detection electrode 26 are provided on the second main surface 24A of the second substrate 24. The second substrate 24 has the second electrode 22 and the detection electrode 26 at positions that are separated in the X-axis direction. The first substrate 23 and the second substrate 24 each have an elongated rectangular flat plate-like shape. The air-blowing direction of the pump 30 in the flow path 25 (the movement direction of the charged particles CP) coincides with the longitudinal direction of the first substrate 23 and the second substrate 24 (the X-axis direction). The first electrode 21 and the second electrode 22 are disposed on the upstream side in the air-blowing direction (the left side in FIG. 1), and the detection electrode 26 and the deflection electrode 27 are disposed on the downstream side in the air-blowing direction (the right side in FIG. 1).

The first substrate 23 and the second substrate 24 of the present embodiment may be made of any appropriate type of insulating material having electrical insulating properties. Examples of an insulating material include materials having a volume resistivity of 10⁷ Ω·cm or greater (for example, 1010 Ω·cm or greater, 10¹² Ω·cm or greater, and 10¹⁵ Ω·cm or greater) at room temperature (for example, 25° C.). For example, the insulating material may be an organic material, an inorganic material, or the like having the aforementioned volume resistivity. Although this is not a limitation, in the present embodiment, flat-plate-shaped glass substrates are used as the first substrate 23 and the second substrate 24 from a viewpoint that the electrodes can be appropriately formed by using a lithography technology. Although there is no limitation on the thickness of the first substrate 23 and the second substrate 24, for example, the thickness may be in the range of about 0.1 mm to about 1 mm (as an example, 0.5 mm, 0.7 mm, or the like).

The detection electrode 26 is an element that receives the charges of the charged particles CP introduced into the detection cell 20 by contacting the charged particles CP. The detection electrode 26 is a third electrode that is arranged on the downstream side of the flow path 25 relative to the first electrode 21 and the second electrode 22. The detection electrode 26 has a collection surface that receives the charged particles CP. The detection electrode 26 is connected with the controller 40. With such a configuration, the detection electrode 26 can grasp the amount of the charged particles CP received at the collection surface with the controller 40. Detailed configuration of the detection electrode 26 will be described below.

The deflection electrode 27 is an element for deflecting the charged particles CP toward the detection electrode 26 so that the charged particles CP introduced into the detection cell 20 can be collected by the detection electrode 26. The deflection electrode 27 is an electrode that is arranged on the downstream side of the flow path 25 relative to the first electrode 21 and the second electrode 22. The deflection electrode 27 is disposed to face the detection electrode 26. The deflection electrode 27 is connected to a second potential adjuster 42 described below. When a voltage is applied by the second potential adjuster 42, it is possible for the deflection electrode 27 to form an electric field, for deflecting the charged particles CP toward the detection electrode 26, between the deflection electrode 27 and the detection electrode 26. A space between the detection electrode 26 and the deflection electrode 27 is a detection space for detecting the charged particles CP that have passed through the ion separation space.

The shape of each of the detection electrode 26 and the deflection electrode 27 is not particularly limited. The thickness of each of the detection electrode 26 and the deflection electrode 27 may be, for example, about 1 μm or less, typically 600 nm or less, and, for example, 500 nm or less, 400 nm or less, 200 nm or less, or the like. The thicknesses of the detection electrode 26 and the deflection electrode 27 may be independently set to about 10 nm or greater, typically 50 nm or greater, and, for example 100 nm or greater. The material and the structure of each of the detection electrode 26 and the deflection electrode 27 may be the same as those of the first electrode 21 and the second electrode 22 described above.

The pump 30 is an element for moving an ambient gas, including the charged particles CP, in the flow direction through the detection cell 20. The pump 30 of the present embodiment is set on the downstream side of the detection cell 20 in the flow direction. Any type of air-blowing devices can be used as the pump 30, as long as the device can move the charged particles CP generated by the ionization source 10 to the detection cell 20 described below with a predetermined speed. The air-blowing mechanism of the pump 30 is not particularly limited, and the pump 30 may be an air-blowing device of a diaphragm type, a rotary blade type, a piston type, a rotary vane type, or the like. Depending on the size and the like of the detection cell 20, for example, a micro-blower whose maximum discharge pressure is about 0.03 MPa or less and air-moving rate is about 1 L/min or less can be used as the pump 30. For example, a micro-blower that moves a diaphragm by using high-frequency vibration due to piezoelectric ceramics (for example, ultrasonic vibration) may be used as the pump 30 in the present embodiment, because such a micro-blower can blow air while suppressing pulsation.

The controller 40 is an element that controls driving of the analyzer 1. As illustrated in FIG. 2, the controller 40 of the present embodiment is connected with the detection cell 20. To be more specific, the controller 40 is connected with the first electrode 21, the second electrode 22, the detection electrode 26, and the deflection electrode 27, and is configured to be capable of controlling the operations of these. Moreover, the controller 40 of the present embodiment is connected to the ionization source 10 and the pump 30, and is connectable with an external power supply for supplying electric power to the analyzer 1.

The controller 40 is a microcomputer including the following: an interface (I/F) that sends and receives various information items and the like; a central processing unit (CPU) that executes commands of a control program; a read only memory (ROM) that stores programs to be executed by the CPU; a random access memory (RAM) that is used as a working area in which programs are developed; a memory M that stores various information items; a timer T having a time-measuring function; and the like. Although this is not a limitation, the ROM may store, for example, the following: a computer program, a data base, and a data table that are used to cause each of a first potential adjuster 41 and the second potential adjuster 42 described below to apply a voltage; a computer program, a data base, and a table for performing various analyses based on the amount of the charged particles CP that have been detected; and the like. Moreover, the memory M can store, for example, ID information of a sample to be analyzed, information regarding the amount of the charged particles CP that have been detected, information used for various analyses, information regarding analysis results and the like, and the like.

The controller 40 includes the first potential adjuster 41, the second potential adjuster 42, a measurer 43, an ionization source controller 44, and a flow rate adjuster 45. These portions may be independent pieces of hardware, or may be functionally implemented in programs to be executed by the CPU.

The first potential adjuster 41 is an element that adjusts a potential difference generated between the first electrode 21 and the second electrode 22. The first potential adjuster 41 generates a potential difference (filter voltage) between the first electrode 21 and the second electrode 22, and thereby an electric field is formed between the first electrode 21 and the second electrode 22. Here, although the mobility of ions is constant irrespective of electric field intensity in a low electric field, the value of the mobility of ions varies depending on electric field intensity in a high electric field. For this reason, the first potential adjuster 41 includes a variable voltage generator, which is typically a pulse voltage generating device, so that the first potential adjuster 41 can apply a dispersion voltage (DV) having, for example, a rectangular waveform. The dispersion voltage DV applied between the first electrode 21 and the second electrode 22 is a bipolar pulse voltage having both of positive and negative polarities. Typically, the potentials at both of positive and negative polarities can be switched unsymmetrically. The voltage waveform is an asymmetrical pulse waveform that alternately includes a period TH in which the voltage is at a high voltage level VH for generating a high electric field and a period TL in which the voltage is at a low voltage level VL for generating a low electric field. In this voltage waveform, the time average of the voltage is set to be zero.

In the ion separation space between the first electrode 21 and the second electrode 22, flow of a carrier gas (typically neutral) including the charged particles CP is formed with a constant flow speed, due to driving of the pump 30 by the flow rate adjuster 45 described below. Here, when the first potential adjuster 41 applies a voltage having the high voltage level VH, a high electric field is formed in the ion separation space. When the first potential adjuster 41 applies a voltage having the low voltage level VL, a low electric field is formed in the ion separation space. The high electric field and the low electric field have different polarities. When the charged particles CP are moved to such an environment in which asymmetric electric fields are alternately generated, the charged particles CP travel along a zigzag path while being attracted alternately to the first electrode 21 and the second electrode 22. At this time, the charged particles CP that have been greatly deflected toward the first electrode 21 or toward the second electrode 22 collide with the first electrode 21 or the second electrode 22 and cannot pass through the flow path 25. Only the charged particles CP that have balanced between the first electrode 21 and the second electrode 22 pass through the flow path 25 and are moved to the detection electrode 26 on the downstream side. It is possible to change ionic species that pass through the flow path 25 as follows. That is, ionic species can be changed by, for example, causing the first potential adjuster 41 to apply a compensation voltage (CV), while changing the amplitude thereof, between the first electrode 21 and the second electrode 22 in such a way that the compensation voltage CV overlaps the dispersion voltage DV. The compensation voltage CV is a direct-current voltage, and it is possible to sequentially move ionic species having different mobilities by changing the compensation voltage CV with a constant rate of change and a period TCV for each predetermined dispersion voltage DV.

The second potential adjuster 42 is an element that applies a predetermined potential difference between the detection electrode 26 and the deflection electrode 27. The second potential adjuster 42 in the present embodiment is connected to the deflection electrode 27, and is configured to apply a potential to the deflection electrode 27. If the charged particles CP introduced into the detection cell 20 are positive ions, the second potential adjuster 42 adjusts the potential of the deflection electrode 27 so that the deflection electrode 27 has a high potential relative to the detection electrode 26. If the charged particles CP introduced into the detection cell 20 are negative ions, the second potential adjuster 42 adjusts the potential of the deflection electrode 27 so that the deflection electrode 27 has a low potential relative to the detection electrode 26. Thus, it is possible to deflect the charged particles CP that have passed through the ion separation space toward the detection electrode 26.

The measurer 43 is an element that detects the number of the charged particles CP that have reached the detection electrode 26. The measurer 43 is connected to the detection electrode 26, and acquires the ion amount by converting an electric current value based on the amount of the charged particles CP that have reached the detection electrode 26 into a voltage value via a transimpedance circuit. The measurer 43 may be configured, not only to measure the amount of the charged particles CP, but also to measure the charged particles CP qualitatively and quantitatively by, for example, in cooperation with the first potential adjuster 41. Information regarding the amount of the charged particles CP measured by the measurer 43 and the like is stored, for example, in the memory M.

The ionization source controller 44 is connected to the ionization source 10, and is configured to control the operation of the ionization source 10. The ionization source controller 44 can switch the polarity of the charged particles CP between positive and negative by controlling the operation of the ionization source 10. Although this is not a limitation, when the ionization source controller 44 caused the ionization source 10 to generate negatively charged particles CP, the first potential adjuster 41 and the second potential adjuster 42 respectively adjust voltages applied to the first electrode 21 and the deflection electrode 27 so that the negatively charged particles CP can pass through the flow path 25. When the ionization source controller 44 caused the ionization source 10 to generate positively charged particles CP, the first potential adjuster 41 and the second potential adjuster 42 respectively adjust voltages applied to the first electrode 21 and the deflection electrode 27 so that the positively charged particles CP can pass through the flow path 25.

The flow rate adjuster 45 is connected to the pump 30, and is configured to be capable of controlling the operation of the pump 30. The flow rate adjuster 45 can adjust the flow speed and the like of a gas in the detection cell 20 by, for example, controlling the timings of driving and stopping the pump 30 and the rotation speed of a fan included in the pump 30.

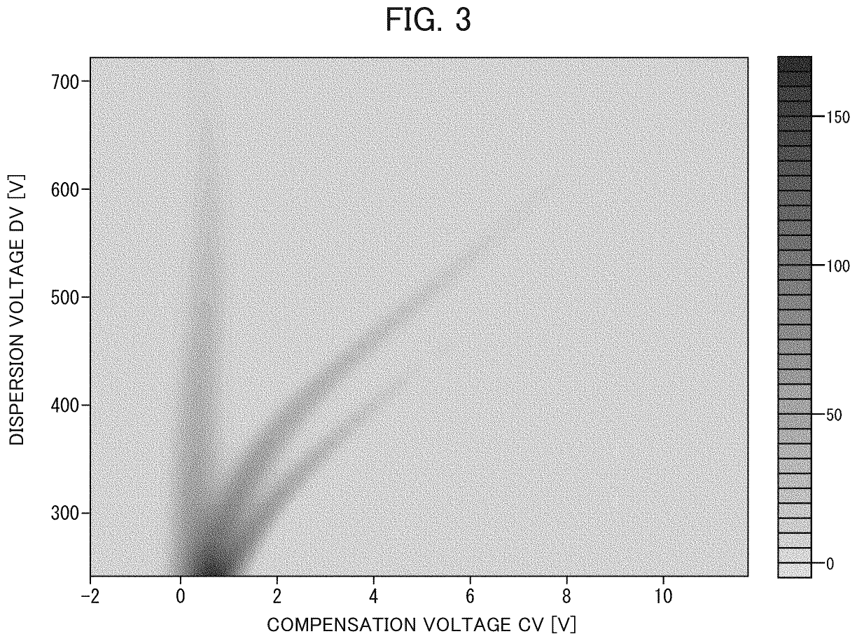

It is possible to obtain a FAIMS spectrum illustrated in FIG. 3 from the relationship between the dispersion voltage DV and the compensation voltage CV, which are applied between the first electrode 21 and the second electrode 22 by the first potential adjuster 41, and an electric signal from the detection electrode 26. FIG. 3 is a map graph illustrating an example of the relationship between the analysis condition (the compensation voltage DV and the dispersion voltage CV) and the amount of sample ions (ionic electric current) detected under the analysis condition. In FIG. 3, the vertical axis represents the dispersion voltage DV (whose unit is “V”) and the horizontal axis represents the compensation voltage CV (whose unit is “V”). In the graph of FIG. 3, a condition under which a larger amount of sample ions are detected are illustrated with dark shades. In order to obtain the FAIMS spectrum illustrated in FIG. 3, for example, the dispersion voltage DV is set to the minimum value, and a scan with which the compensation voltage CV is changed from a lower limit voltage VCVL to an upper limit voltage VCVH is performed. Then, the dispersion voltage DV is changed to a value larger than the minimum value, and the scan of the compensation voltage CV is performed again. The scan of the compensation voltage CV is performed until the dispersion voltage DV becomes the maximum value.

Next, the ionization source 10 will be described. The ionization source 10 is a device that generates charged particles CP by ionizing atoms and molecules of a chemical compound (sample) to be analyzed. In the present embodiment, an atmospheric pressure chemical ionization (APCI) method, which is a type of chemical ionization method, is used as the ionization method of the ionization source 10. To be specific, the ionization source 10 ionizes atoms and molecules of a sample by generating corona discharge under an atmospheric pressure environment. The charged particles CP generated by the ionization source 10 are moved by an airflow generated by the pump 30, and thereby flow from the upstream side toward the downstream side through the flow path 25 of the detection cell 20.

Specific configurations of the ionization source 10 will be described. As illustrated in FIG. 1, the ionization source 10 has a fourth electrode (the other electrode) 11 provided on the first substrate 23 and a fifth electrode (one electrode) 12 provided on the second substrate 24. The fourth electrode 11 is provided on the first main surface 23A of the first substrate 23. The fourth electrode 11 is disposed at a position on the upstream side of the flow path 25 relative to the first electrode 21 with a distance therebetween. That is, on the first main surface 23A of the first substrate 23, the fourth electrode 11, the first electrode 21, and the deflection electrode 27 are arranged in order from the upstream side of the flow path 25 with a distance therebetween. The fifth electrode 12 is provided on the second main surface 24A of the second substrate 24. The fifth electrode 12 is disposed at a position on the upstream side of the flow path 25 relative to the second electrode 22 with a distance therebetween. That is, on the second main surface 24A of the second substrate 24, the fifth electrode 12, the second electrode 22, and the detection electrode 26 are arranged in order from the upstream side of the flow path 25 with a distance therebetween.

As illustrated in FIG. 3, the fourth electrode 11 and the fifth electrode 12 of the ionization source 10 are connected to the ionization source controller 44. When the ionization source controller 44 energizes the fourth electrode 11 and the fifth electrode 12, corona discharge is generated between the fourth electrode 11 and the fifth electrode 12. The corona discharge ionizes the atoms and molecules of a sample to generate charged particles CP. As illustrated in FIG. 1, the charged particles CP that have been generated are supplied to the flow path 25 between the fourth electrode 11 and the fifth electrode 12 evenly in the Z-axis direction, and the charged particles CP are not likely to become unevenly distributed near the first main surface 23A or near the second main surface 24A. In the present embodiment, since the filter gap G of the detection cell 20 has been adjusted so that a laminar flow is easily generated in the flow path 25, the charged particles CP, which have been evenly generated in the Z-axis direction in the flow path 25, can easily follow the laminar flow and efficiently flow toward the downstream side, and the charged particles CP are not likely to become stagnant near the first main surface 23A or near the second main surface 24A.

As illustrated in FIG. 1, the fourth electrode 11 and the fifth electrode 12 of the ionization source 10 according to the present embodiment are disposed to be displaced relative to each other on the upstream side and the downstream side of the flow path 25. Here, the filter gap G, which is the gap between the pair of substrates 23 and 24, is at most about several hundred micrometers, and is not large enough to stably generate corona discharge between the fourth electrode 11 and the fifth electrode 12. In this respect, since the fourth electrode 11 and the fifth electrode 12 are disposed to be displaced relative to each other on the upstream side and the downstream side of the flow path 25 as described above, it is possible to make the distance D1 between the fourth electrode 11 and the fifth electrode 12 larger than the filter gap G. Thus, it is possible to stably generate corona discharge between the fourth electrode 11 and the fifth electrode 12, and therefore it is possible to generate the charged particles CP by a sufficient amount. In the present embodiment, the distance D1 between the fourth electrode 11 and the fifth electrode 12 is, for example, in the range of 1.5 mm or greater to 10 mm or less. When the distance D1 is 1.5 mm or greater, it is possible to stably generate corona discharge. When the distance D1 is 10 mm or less, it is possible to reduce the value of a voltage required to be applied to the fourth electrode 11 and the fifth electrode 12 to generate corona discharge. The distance D1 is a linear distance from the fourth electrode 11 to the fifth electrode 12.

The fourth electrode 11 and the fifth electrode 12 are disposed with a distance D2 therebetween on the upstream side and the downstream side of the flow path 25. The distance D2 is a liner distance from the fourth electrode 11 to the fifth electrode 12 in the X-axis direction, and is shorter than the distance D1. To be specific, the fifth electrode 12 is disposed at a position on the upstream side of the flow path 25 relative to the fourth electrode 11 with the distance D2 therebetween, and the fourth electrode 11 is disposed at a position on the downstream side of the flow path 25 relative the fifth electrode 12 with the distance D2 therebetween. The distance D2 between the fourth electrode 11 and the fifth electrode 12 is set in a numerical range such that the distance D1 between the fourth electrode 11 and the fifth electrode 12 is in the range of 1.5 mm or greater to 10 mm or less. Since the filter gap G is in the range of several tens of micrometers or greater to several hundreds of micrometers or less as described above, the distance D2 between the fourth electrode 11 and the fifth electrode 12 is, for example, in the range of several hundred micrometers or greater to several millimeters or less. As described above, since the fourth electrode 11 and the fifth electrode 12 are disposed with the distance D2 therebetween on the upstream side and the downstream side of the flow path 25, compared with a case where the fourth electrode and the fifth electrode are in a positional relationship such that parts thereof overlap, it is possible to increase the distance D1 between the fourth electrode 11 and the fifth electrode 12. Thus, it is possible to stably generate corona discharge between the fourth electrode 11 and the fifth electrode 12, and the charged particles CP can be generated by a larger amount.

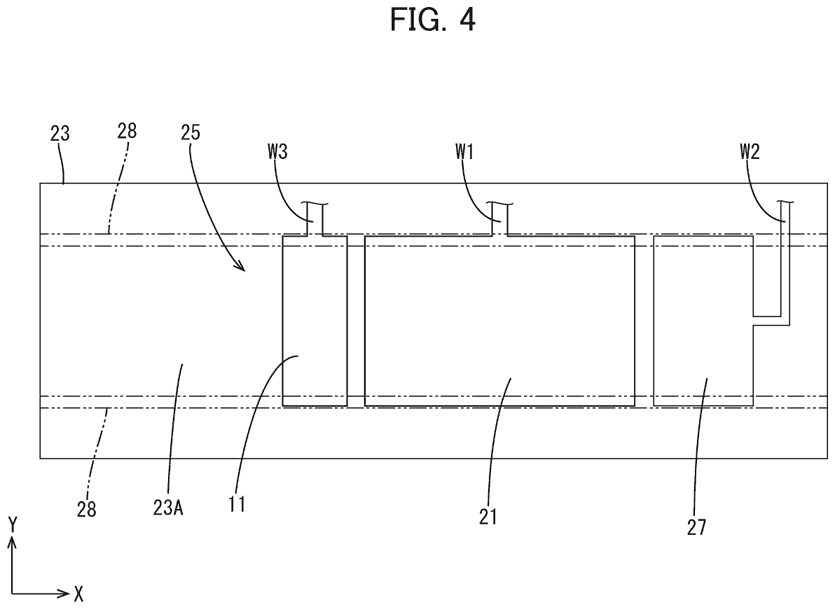

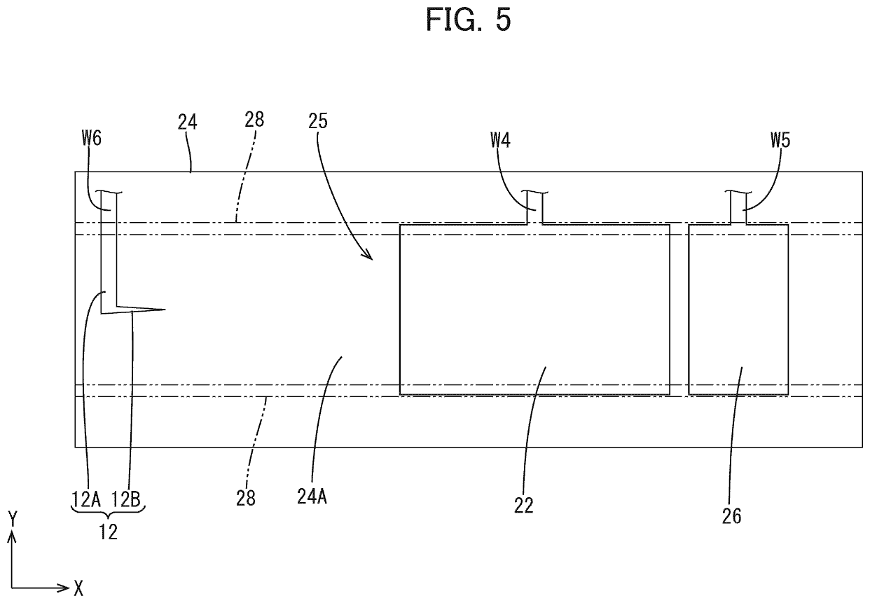

Next, referring to FIGS. 1 and 4 to 6, specific configurations of the detection cell 20 including the ionization source 10 will be described. FIGS. 4 and 5 illustrate, with two-dot chain lines, a pair of spacers 28 that are interposed between the first main surface 23A of the first substrate 23 and the second main surface 24A of the second substrate 24. The pair of spacers 28 are used to maintain the distance between the first substrate 23 and the second substrate 24, that is, the filter gap G, at a predetermined magnitude. The pair of spacers 28 are disposed at positions that are separated with the flow path 25 therebetween in the Y-axis direction, and extend in the X-axis direction. The spacers 28 include a curing agent that cures when at least one of light and heat is applied and spacer particles that are dispersed in the curing agent. The spacer particles are made of, for example, glass fiber or a silicon-based resin in consideration of dispersibility in the curing agent. The particle diameter of the spacer particles is approximately equal to the target value of the filter gap G, and, for example, in the range of about 50 μm to 300 μm.

As illustrated in FIG. 4, the first substrate 23 of the detection cell 20 has a horizontally-elongated rectangular shape in a plan view. The first electrode 21 has a horizontally-elongated rectangular shape in a plan view, is positioned on the first main surface 23A of the first substrate 23 on the upstream side relative to the deflection electrode 27 with a distance therebetween, and is positioned on the downstream side relative to the fourth electrode 11 with a distance therebetween. Both end portions of the first electrode 21 in the Y-axis directions overlap the pair of spacers 28. Accordingly, the first electrode 21 is disposed over the entire width of the flow path 25 in the Y-axis direction. A first lead wire W1, which is disposed on a part of the first main surface 23A of the first substrate 23 outside of one of the spacers 28, is connected to the first electrode 21. The first lead wire W1 is connected to the first potential adjuster 41 (see FIG. 3). The deflection electrode 27 has a rectangular shape that is slightly vertically elongated in a plan view, and is positioned on the first main surface 23A of the first substrate 23 on the downstream side relative to the first electrode 21 with a distance therebetween. Both end portions of the deflection electrode 27 in the Y-axis direction overlap the pair of spacers 28. Accordingly, the deflection electrode 27 is disposed over the entire width of the flow path 25 in the Y-axis direction. A second lead wire W2, which is disposed on a part of the first main surface 23A of the first substrate 23 outside of one of the spacers 28, is connected to the deflection electrode 27. The second lead wire W2 is connected to the second potential adjuster 42 (see FIG. 3). The fourth electrode 11 has a rectangular shape that is slightly vertically elongated in a plan view, and is positioned on the first main surface 23A of the first substrate 23 on the upstream side relative to the first electrode 21 with a distance therebetween. An end portion of the fourth electrode 11 on the upstream side and an end portion of the fourth electrode 11 on the downstream side both extend linearly in the Y-axis direction. Both end portions of the fourth electrode 11 in the Y-axis direction overlap the pair of spacers 28. Accordingly, the fourth electrode 11 is disposed over the entire width of the flow path 25 in the Y-axis direction. A third lead wire W3, which is disposed on a part of the first main surface 23A of the first substrate 23 outside one of the spacers 28, is connected to the fourth electrode 11. The third lead wire W3 is connected to the ionization source controller 44. The lead wires W1 to W3 are respectively led out from the electrodes 11, 21, and 27, to which the lead wires W1 to W3 are connected, toward the same side in the Y-axis direction (the upper side in FIG. 4).

As illustrated in FIG. 5, the second substrate 24 of the detection cell 20 has a horizontally-elongated rectangular shape in a plan view. The second electrode 22 has rectangular shape that is horizontally elongated in a plan view, is positioned on the second main surface 24A of the second substrate 24 on the upstream side relative to the detection electrode 26 with a distance therebetween, and is positioned on the downstream side relative to the fifth electrode 12 with a distance therebetween. Both end portions of the second electrode 22 in the Y-axis directions overlap the pair of spacers 28. Accordingly, the second electrode 22 is disposed over the entire width of the flow path 25 in the Y-axis direction. A fourth lead wire W4, which is disposed on a part of the second main surface 24A of the second substrate 24 outside of one of the spacers 28, is connected to the second electrode 22. The fourth lead wire W4 is grounded. The detection electrode 26 has a slightly vertically-elongated rectangular shape in a plan view, is positioned on the second main surface 24A of the second substrate 24 on the downstream side relative to the second electrode 22 with a distance therebetween. Both end portions of the detection electrode 26 in the Y-axis direction overlap the pair of spacers 28. Accordingly, the detection electrode 26 is disposed over the entire width of the flow path 25 in the Y-axis direction. A fifth lead wire W5, which is disposed on a part of the second main surface 24A of the second substrate 24 outside of one the spacers 28, is connected to the detection electrode 26. The fifth lead wire W5 is connected to the measurer 43. The fifth electrode 12 is positioned on the second main surface 24A of the second substrate 24 on the upstream side relative to the second electrode 22 with a distance therebetween. A sixth lead wire W6, which is disposed on a part of the second main surface 24A of the second substrate 24 outside of one of the spacers 28, is connected the fifth electrode 12. The sixth lead wire W6 is connected to the ionization source controller 44. The lead wires W4 to W6 are respectively led out from the electrodes 12, 22, and 26, to which the lead wires W4 to W6 are connected, toward the same side in the Y-axis direction (the upper side in FIG. 5).

The fifth electrode 12 has a trunk portion 12A and a needle-like portion 12B that is continuous with the trunk portion 12A. The trunk portion 12A extends linearly in the Y-axis direction, and one end of the trunk portion 12A is connected to the sixth lead wire W6. The other end of the trunk portion 12A is positioned near the center of the second substrate 24 in the Y-axis direction. The needle-like portion 12B is continuous with the other end of the trunk portion 12A. The needle-like portion 12B protrudes from the trunk portion 12A toward the second electrode 22 side (the downstream side of the flow path 25, the fourth electrode 11 side) in the X-axis direction. The needle-like portion 12B is tapered, and the width thereof decreases toward the second electrode 22 in the X-axis direction. When the fifth electrode 12 having such a configuration is energized, an electric field is intensively generated near the needle-like portion 12B, electrolytic dissociation occurs mainly around the needle-like portion 12B, and thus it is possible to efficiently generate the charged particles CP.

The radius of curvature, which is the degree of sharpness, of the pointed end of the needle-like portion 12B of the fifth electrode 12 is in the range of 30 μm to 200 μm. In addition, the fifth electrode 12 is disposed at a position such that the distance D1 between the needle-like portion 12B and the fourth electrode 11 is in the range of 1.5 mm to 10 mm. If the radius of curvature of the needle-like portion 12B is less than 30 μm, deterioration of the needle-like portion 12B due to corona discharge tends to occur, and a problem of durability may occur. In this respect, since the radius of curvature of the needle-like portion 12B is 30 μm or greater, deterioration of the needle-like portion 12B due to corona discharge is suppressed. Thus, the fifth electrode 12 has sufficient durability. Here, if the ratio of the distance D1 to the radius of curvature of the pointed end of the needle-like portion 12B is less than 50, it is concerned that corona discharge may not be generated stably and the charged particles CP may not be sufficiently generated. In this respect, since the distance D1 between the fifth electrode 12 and the fourth electrode 11 is 1.5 mm or greater, even if the radius of curvature of the needle-like portion 12B is 30 μm, which is the lower limit, the ratio of the distance D1 to the radius of curvature is 50 or greater. Thus, it is possible to stably generate corona discharge. If the distance D1 between the fifth electrode 12 and the fourth electrode 11 exceeds 10 mm, a voltage that needs to be applied to the fourth electrode 11 and the fifth electrode 12 to generate corona discharge becomes too high, and it may become difficult to handle this. In this respect, since the distance D1 between the fifth electrode 12 and the fourth electrode 11 is 10 mm or greater, it is possible to reduce the value of a voltage that needs to be applied to the fourth electrode 11 and the fifth electrode 12 to generate corona discharge. Moreover, since the radius of curvature of the needle-like portion 12B is 200 μm or less, even if the distance D1 between the fifth electrode 12 and the fourth electrode 11 is 10 mm, which is the upper limit, the ratio of the distance D1 to the radius of curvature is 50 or greater. Thus, it is possible to stably generate corona discharge.

In the present embodiment, a known photolithography method is used to form the electrodes 11, 12, 21, 22, 26, and 27 on the substrates 23 and 24. For example, when the fifth electrode 12, the second electrode 22, the detection electrode 26, and the like are to be formed on the second substrate 24, an electroconductive film made of a predetermined electroconductive material and a photoresist film are successively formed on the second main surface 24A of the second substrate 24, the photoresist film is exposed to light and developed to form a mask, and patterning of the electroconductive film is performed by etching the electroconductive film by using the mask. Thus, the fifth electrode 12, the second electrode 22, the detection electrode 26, and the like can be formed on the second main surface 24A of the second substrate 24. Since the fifth electrode 12 is formed by using a photolithography method in this way, it is possible to microscopically form the shape of the needle-like portion 12B. Thus, it is possible to easily adjust the radius of curvature of the pointed end of the needle-like portion 12B, and it is possible to make the radius of curvature be in the aforementioned numerical range with high reproducibility. When the fourth electrode 11, the first electrode 21, the deflection electrode 27, and the like to be formed on the first substrate 23, the same method (photolithography method) as that of forming the second substrate 24 may be used. The electroconductive film may be a metal film made of a metal material, and, as the metal material in this case, titanium (Ti), aluminum (Al), copper (Cu), gold (Au), or the like can be used. The electroconductive film may be a transparent electrode film made of a transparent electrode material (oxide electroconductive material), and, as the transparent electrode material in this case, zinc oxide (ZnO), indium tin oxide (ITO), indium zinc oxide (IZO), or the like can be used.

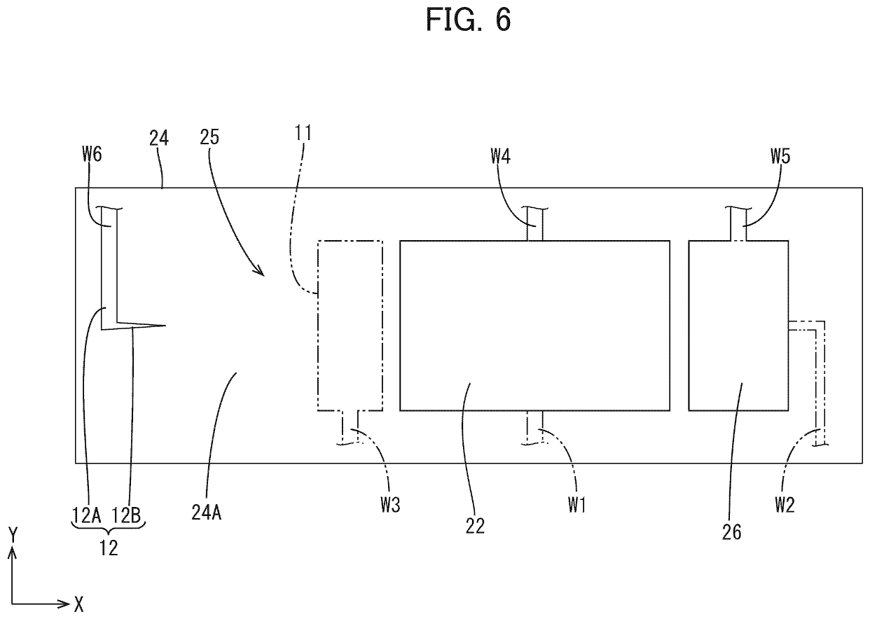

In the present embodiment, as illustrated in FIGS. 1 and 6, among the fourth electrode 11 and the fifth electrode 12, the fifth electrode 12, which is disposed on the upstream side of the flow path 25, is the positive electrode, and the fourth electrode 11, which is disposed on the downstream side of the flow path 25, is the negative electrode. FIG. 6 illustrates elements provided on the first substrate 23 with two-dot chain lines. When the ionization source controller 44 energizes the fifth electrode 12 and the fourth electrode 11, an electric field is intensively generated near the needle-like portion 12B of the fifth electrode 12, which is the positive electrode, electrolytic dissociation occurs mainly around the needle-like portion 12B, and thus the charged particles CP are efficiently generated. At this time, an ionic wind from the fifth electrode 12, which is the positive electrode, toward the fourth electrode 11, which is the negative electrode, is generated. Since the fifth electrode 12, which is the positive electrode, is disposed on the upstream side of the flow path 25 and the fourth electrode 11, which is the negative electrode, is disposed on the downstream side of the flow path 25, the ionic wind generated by corona discharge flows from the upstream side toward the downstream side of the flow path 25. Thus, the flowability of the charged particles CP in the flow path 25 is improved.

As heretofore described, the detection cell (detector) 20 according to the present embodiment includes: the first substrate 23 having the first main surface 23A; the second substrate 24 having the second main surface 24A that faces the first main surface 23A of the first substrate 23 with a distance therebetween; the first electrode 21 that is provided on the first main surface 23A of the first substrate 23; the second electrode 22 that is provided on the second main surface 24A of the second substrate 24, that faces the first electrode 21 with a distance therebetween, and that forms the flow path 25 for the charged particles (ions) CP, which are to be detected, between the second electrode 22 and the first electrode 21; the detection electrode (third electrode) 26 that is provided on the first main surface 23A of the first substrate 23 or the second main surface 24A of the second substrate 24, that is disposed on the downstream side of the flow path 25 relative to the first electrode 21 or the second electrode 22, and that collects the charged particles CP; the fourth electrode 11 that is provided on the first main surface 23A of the first substrate 23 and that is disposed on the upstream side of the flow path 25 relative to the first electrode 21; and the fifth electrode 12 that is provided on the second main surface 24A of the second substrate 24, that is disposed on the upstream side of the flow path 25 relative to the second electrode 22, and that generates corona discharge between the fifth electrode 12 and the fourth electrode 11. The fourth electrode 11 and the fifth electrode 12 are disposed to be displaced relative to each other on the upstream side and the downstream side of the flow path 25.

The charged particles CP are supplied to the flow path 25 due to corona discharge that is generated as the fourth electrode 11 and the fifth electrode 12 are energized. Whether or not to pass the charged particles CP through the flow path 25 is controlled by an electric field that is generated between the first electrode 21 and the second electrode 22, which are disposed on the downstream side of the flow path 25 relative to the fourth electrode 11 and the fifth electrode 12. The charged particles CP that have passed through the flow path 25 are collected by the detection electrode 26, which is disposed on the downstream side of the flow path 25 relative to the first electrode 21 or the second electrode 22, and are detected. Since the fourth electrode 11 and the fifth electrode 12 are disposed to be displaced relative to each other on the upstream side and the downstream side of the flow path 25, it is possible to make the distance D1 between the fourth electrode 11 and the fifth electrode 12 larger than the gap between the pair of substrates 23 and 24. Thus, it is possible to stably generate corona discharge between the fourth electrode 11 and the fifth electrode 12, and therefore it is possible to generate the charged particles CP by a sufficient amount.

The fourth electrode 11 and the fifth electrode 12 are disposed on the upstream side and the downstream side of the flow path 25 with the distance D2 therebetween. Since the fourth electrode 11 and the fifth electrode 12 are disposed on the upstream side and the downstream side of the flow path 25 with the distance D2 therebetween, compared with a case where the fourth electrode and the fifth electrode are in a positional relationship such that parts thereof overlap, it is possible to increase the distance D1 between the fourth electrode 11 and the fifth electrode 12. Thus, it is possible to more stably generate corona discharge between the fourth electrode 11 and the fifth electrode 12, and it is possible to generate the charged particles CP by a sufficient amount.

The fifth electrode 12, which is one electrode among the fourth electrode 11 and the fifth electrode 12, has the needle-like portion 12B, whose width decreases toward the fourth electrode 11, which is the other electrode, in the first direction that is along the flow path 25. When the fifth electrode 12, which is one electrode, and the fourth electrode 11, which is the other electrode, are energized, an electric field is intensively generated near the needle-like portion 12B, electrolytic dissociation occurs mainly around the needle-like portion 12B, and thus it is possible to efficiently generate the charged particles CP.

The radius of curvature of the needle-like portion 12B is in the range of 30 μm to 200 μm, and the distance D1 between the fifth electrode 12, which is one electrode, and the fourth electrode 11, which is the other electrode, is in the range of 1.5 mm to 10 mm. Since the radius of curvature of the needle-like portion 12B is 30 μm or greater, deterioration of the needle-like portion 12B due to corona discharge is suppressed. Thus, the fifth electrode 12, which is one electrode, has sufficient durability. Since the distance D1 the fifth electrode 12, which is one electrode, and the fourth electrode 11, which is the other electrode, is 1.5 mm or greater, even if the radius of curvature of the needle-like portion 12B is 30 μm, which is the lower limit, the ratio of the distance D1 to the radius of curvature is 50 or greater. Thus, it is possible to stably generate corona discharge. Since the distance D1 between the fifth electrode 12, which is one electrode, and the fourth electrode 11, which is the other electrode, is 10 mm or greater, it is possible to reduce the value of a voltage that needs to be applied to the fifth electrode 12, which is one electrode, and the fourth electrode 11, which is the other electrode. Since the radius of curvature of the needle-like portion 12B is 200 μm or less, even if the distance D1 between the fifth electrode 12, which is one electrode, and the fourth electrode 11, which is the other electrode, is 10 mm, which is the upper limit, the ratio of the distance D1 to the radius of curvature is 50 or greater. Thus, it is possible to stably generate corona discharge.

Among the fourth electrode 11 and the fifth electrode 12, the fifth electrode 12, which is disposed on the upstream side of the flow path 25, is the positive electrode, and the fourth electrode 11, which is disposed on the downstream side of the flow path 25, is the negative electrode. When corona discharge is generated as the fifth electrode 12, which is the positive electrode, and the fourth electrode 11, which is the negative electrode, are energized, an ionic wind from the fifth electrode 12, which is the positive electrode, toward the fourth electrode 11, which is the negative electrode, is generated. Since the fifth electrode 12, which is the positive electrode, is disposed on the upstream side of the flow path 25 and the fourth electrode 11, which is the negative electrode, is disposed on the downstream side of the flow path 25, the ionic wind generated by corona discharge flows from the upstream side toward the downstream side of the flow path 25. Thus, the flowability of the charged particles CP in the flow path 25 is improved.

### Second Embodiment

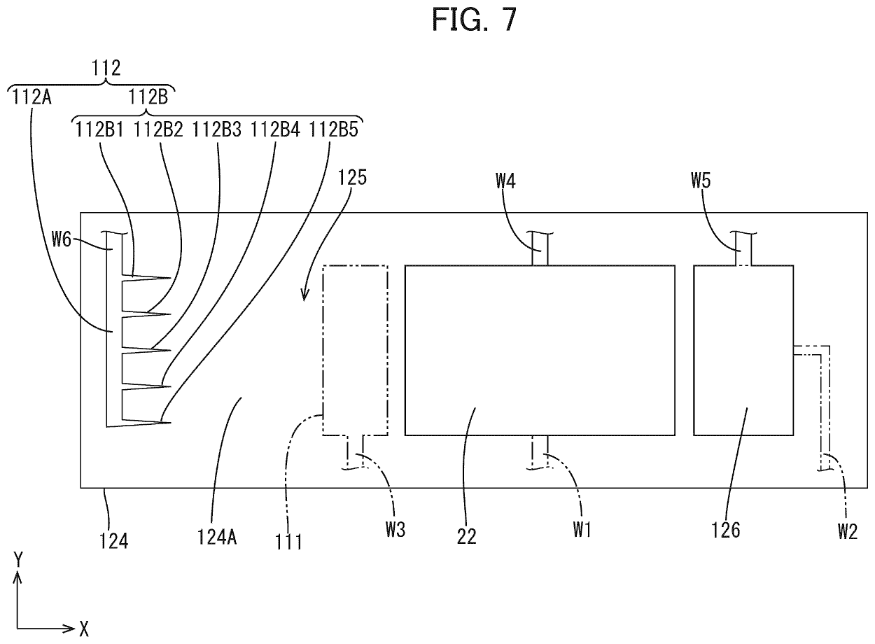

Referring to FIG. 7, a second embodiment will be described. In the second embodiment, a case where the configuration of a fifth electrode 112 is changed will be described. Redundant descriptions of structures, operations, and effects that are the same as those of the first embodiment will be omitted.

As illustrated in FIG. 7, the fifth electrode 112 according to the present embodiment has a plurality of needle-like portions 112B. The plurality of needle-like portions 112B are arranged with a distance therebetween in the Y-axis direction, and all of the needle-like portion 112B are continuous with a trunk portion 112A. Accordingly, the trunk portion 112A, which is connected to the ionization source controller 44, simultaneously applies a voltage to the plurality of needle-like portions 112B. To be specific, the number of the needle-like portions 112B is, for example, five. The needle-like portions 112B include, from the upper side of FIG. 7, a first needle-like portion 112B1, a second needle-like portion 112B2, a third needle-like portion 112B3, a fourth needle-like portion 112B4, and a fifth needle-like portion 112B5. The plurality of needle-like portions 112B will be referred to by names with ordinal numbers, like “the first needle-like portion, . . . , the fifth needle-like portion”, when these are to be distinguished from each other, and referred to by names without ordinary numbers when these are to be collectively called without being distinguished from each other.

The five needle-like portions 112B are arranged on a second main surface 124A of a second substrate 124 at substantially regular distances in the Y-axis direction. The third needle-like portion 112B3 is disposed at a position at substantially the center of the second main surface 124A of the second substrate 124 in the Y-axis direction. The second needle-like portion 112B2 and the fourth needle-like portion 112B4, between which the third needle-like portion 112B3 is interposed in the Y-axis direction, are disposed at substantially the same distance from the third needle-like portion 112B3. The first needle-like portion 112B1 is disposed on the opposite side from the third needle-like portion 112B3 with respect to the second needle-like portion 112B2 with a distance therebetween in the Y-axis direction. The fifth needle-like portion 112B5 is disposed on the opposite from the third needle-like portion 112B3 with respect to the fourth needle-like portion 112B4 with a distance therebetween in the Y-axis direction. The first needle-like portion 112B1 and the fifth needle-like portion 112B5 are disposed near both ends of a flow path 125 in the Y-axis direction. With the configuration described above, when a voltage from the ionization source controller 44 is applied simultaneously to the five needle-like portions 112B via the trunk portion 112A, an electric field is generated near each of the five needle-like portions 112B, and charged particles CP are generated. Since the charged particles CP are generated at each of five positions in the flow path 125 that are separated with a distance therebetween in the Y-axis direction, the charged particles CP can easily spread in the Y-axis direction in the flow path 125. Thus, the amount of the charged particles CP collected and detected by a detection electrode 126 is increased, and therefore the detection sensitivity is improved. Moreover, even if one of the five needle-like portions 112B deteriorates, the remaining needle-like portions 112B can maintain corona discharge.

In contrast, a fourth electrode 111 has a vertically-elongated rectangular shape extending linearly in the Y-axis direction. The fourth electrode 111 is disposed over the entire width of the flow path 125 in the Y-axis direction, and crosses all of the needle-like portions 112B. Accordingly, the distance between an end portion of the fourth electrode 111 on the upstream side and the five needle-like portions 112B, which are arranged with a distance therebetween in the Y-axis direction, is uniform. Thus, it is possible to equalize electric fields generated by the plurality of needle-like portions 112B, which have the same potential via the trunk portion 112A, and therefore it is possible to stably generate corona discharge.

As heretofore described, according to the present embodiment, the fifth electrode 112, which is one electrode, has the plurality of needle-like portions 112B, and the plurality of needle-like portions 112B are arranged with a distance therebetween in the second direction that is along the first main surface 23A or the second main surface 124A and that intersects the first direction. Since the charged particles CP are generated as an electric field is generated at each of the plurality of needle-like portions 112B, which are arranged with a distance therebetween in the second direction, the charged particles CP can easily spread in the second direction in the flow path 125. Thus, the amount of the charged particles CP collected and detected by the detection electrode 126 is increased, and therefore the detection sensitivity is improved. Moreover, even if one of the plurality of needle-like portions 112B deteriorates, the remaining needle-like portions 112B can maintain corona discharge.

The fifth electrode 112, which is one electrode, has the trunk portion 112A, which extends in the second direction and is continuous with the plurality of needle-like portions 112B, and the fourth electrode 111, which is the other electrode, linearly extends in the second direction. By connecting the trunk portion 112A to the ionization source controller (power source) 44, it is possible to apply a voltage simultaneously to the plurality of needle-like portions 112B. The distance between the plurality of needle-like portions 112B, which are arranged with a distance therebetween in the second direction, and the fourth electrode 111, which is the other electrode that linearly extends in the second direction, is uniform. Thus, it is possible to equalize electric fields generated by the plurality of needle-like portions 112B, which have the same potential via the trunk portion 112A, and therefore it is possible to stably generate corona discharge.

### Third Embodiment

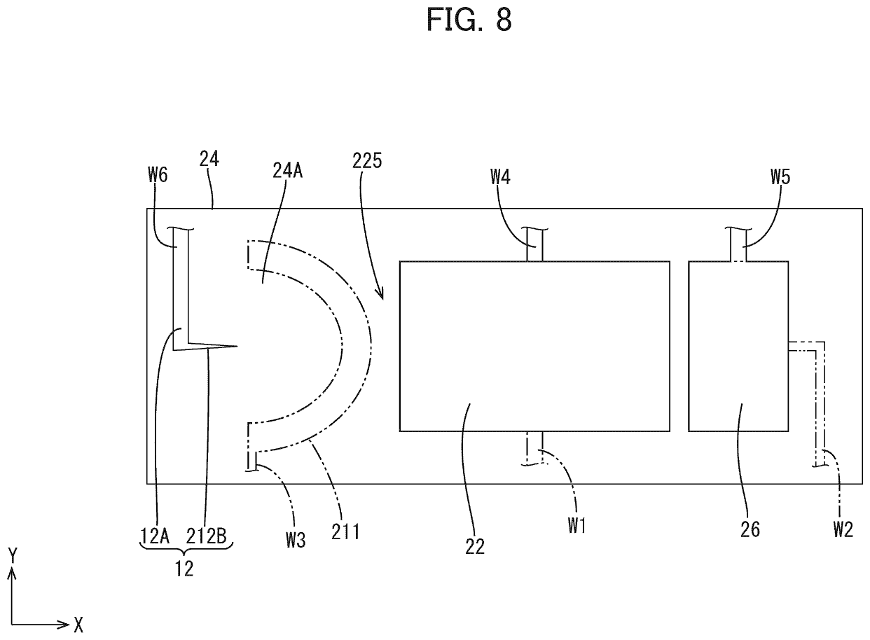

Referring to FIG. 8, a third embodiment will be described. In the third embodiment, a case where the configuration of a fourth electrode 211 is changed from the first embodiment will be described. Redundant descriptions of structures, operations, and effects that are the same as those of the first embodiment will be omitted.

As illustrated in FIG. 8, the fourth electrode 211 according to the present embodiment has an arc shape in a plan view. The center of curvature of the fourth electrode 211, having an arc shape, is positioned on the upstream side of a flow path 225 in the X-axis direction, that is, on the needle-like portion 212B side. The fourth electrode 211 is disposed in such a way that the center of curvature thereof is near the pointed end of the needle-like portion 212B. With such a configuration, the distance between an end portion of the fourth electrode 211, having an arc shape, on the upstream side (the needle-like portion 212B side) and the needle-like portion 212B is uniform. Thus, it is possible to uniformize an electric field generated at the end portion of the fourth electrode 211 on the upstream side, and therefore it is possible to stably generate corona discharge and to generate the charged particles CP by a sufficient amount.

As heretofore described, according to the present embodiment, the fourth electrode 211, which is the other electrode, has an arc shape, and the center of curvature thereof is positioned on the needle-like portion 212B side in the first direction. With this configuration, the distance between the needle-like portion 212B and the end portion of the fourth electrode 211, which is the other electrode having an arc shape, on the needle-like portion 212B side is uniform. Thus, it is possible to uniformize an electric field generated at the end portion of the fourth electrode 211 on the needle-like portion 212B side, and therefore it is possible to stably generate corona discharge.

### Fourth Embodiment

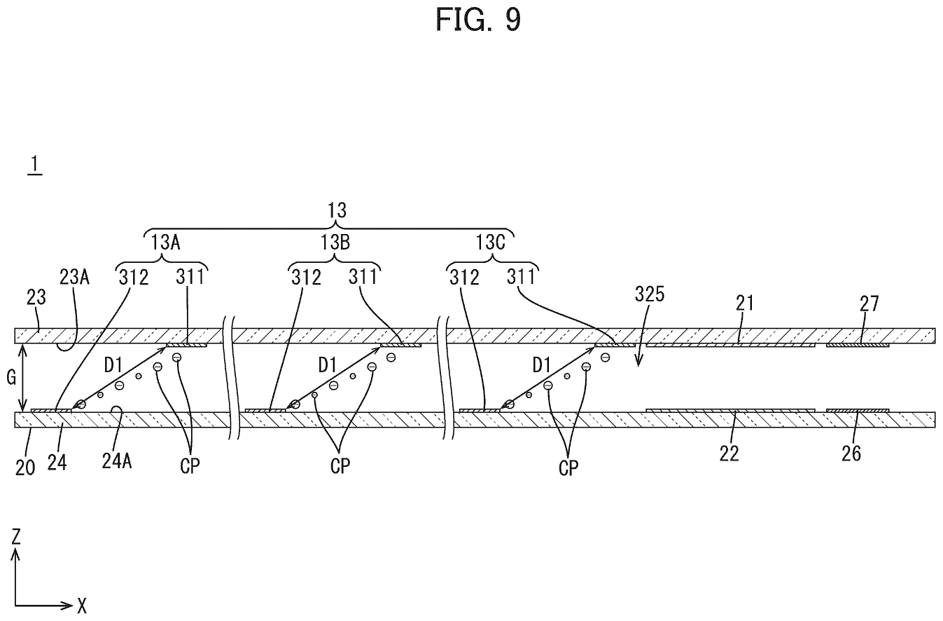

Referring to FIG. 9, a fourth embodiment will be described. In the fourth embodiment, a case where the number of fourth electrodes 311 and fifth electrodes 312 are changed from the first embodiment will be described. Redundant descriptions of structures, operations, and effects that are the same as those of the first embodiment will be omitted.

As illustrated in FIG. 9, according to the present embodiment, a plurality of fourth electrodes 311 and a plurality of fifth electrodes 312 are provided. A fourth electrode 311 and a fifth electrode 312 that are disposed to be displaced relative to each other on the upstream side and the downstream side of a flow path 325 and that generate corona discharge constitute one electrode set 13. In the present embodiment, a plurality of electrode sets 13 are disposed at positions that are separated with a distance therebetween in the X-axis direction. To be specific, the number of the electrode sets 13 is, for example, three. The electrode sets 13 include a first electrode set 13A, a second electrode set 13B, and a third electrode set 13C in order from the upstream side of the flow path 325. The plurality of electrode sets 13 will be referred to by names with ordinal numbers, like “a first electrode set, . . . , a third electrode set”, when distinguishing these from each other, and referred to by names without ordinary numbers when calling these collectively without distinguishing between these.

A sufficient distance is provided between the electrode sets 13 that are adjacent to each other in the X-axis direction so that corona discharge may not occur between the electrodes 311 and 312 that constitute different electrode sets 13. To be specific, the distance between the fourth electrode 311 of the first electrode set 13A and the fifth electrode 312 of the second electrode set 13B is greater than the distance D1 between the fourth electrode 311 and the fifth electrode 312 of the first electrode set 13A and the distance D1 between the fourth electrode 311 and the fifth electrode 312 of the second electrode set 13B. The distance between the fourth electrode 311 of the second electrode set 13B and the fifth electrode 312 of the third electrode set 13C is greater than the distance D1 between the fourth electrode 311 and the fifth electrode 312 of the second electrode set 13B and the distance D1 between the fourth electrode 311 and the fifth electrode 312 of the third electrode set 13C. With such a configuration, an ionic wind is generated at each of a plurality of positions in the flow path 325 that are separated with a distance therebetween in the X-axis direction. Thus, the flowability of the charged particles CP in the flow path 325 is further improved, and therefore it becomes possible to omit the pump 30 described in the first embodiment (see FIG. 1).

As heretofore described, according to the present embodiment, the plurality of electrode sets 13, each of which is composed of the fourth electrode 311 and the fifth electrode 312, are disposed at positions that are separated with a distance therebetween in the first direction that is along the flow path 325. An ionic wind is generated at each of a plurality of positions in the flow path 325 that are separated with a distance therebetween in the first direction. Thus, the flowability of the charged particles CP in the flow path 325 is further improved, and therefore it becomes possible to omit a device, such as the pump 30, for forcibly causing the charged particles CP to flow through the flow path 325.

### Other Embodiments

The technology disclosed in the present specification is not limited to the embodiments that have been described above with reference to the drawings, and, for example, the following embodiments are also included in the technical scope.

(1) The fourth electrodes 11, 111, 211, and 311 and the fifth electrodes 12, 112, and 312 may be disposed in such a way that parts thereof overlap.

(2) The fourth electrodes 11, 111, 211, and 311 may be negative electrodes, and the fifth electrodes 12, 112, and 312 may be positive electrodes.

(3) In the flow paths 25, 125, 225, and 325, the fifth electrodes 12, 112, and 312 may be disposed on the downstream side relative to the fourth electrodes 11, 111, 211, and 311, and the fourth electrodes 11, 111, 211, and 311 may be disposed on the upstream side relative to the fifth electrodes 12, 112, and 312.

(4) The needle-like portions 12B, 112B, and 212B may be provided in the fourth electrodes 11, 111, 211, and 311. In this case, the fifth electrodes 12, 112, and 312 may be strip-shaped electrodes as with the fourth electrodes 11, 111, and 311 in the first, second, and third embodiments, or may be an arc-shaped electrodes as with the fourth electrode 211 in the third embodiment.

(5) The fourth electrodes 11, 111, 211, and 311 may be provided on the second substrates 24 and 124, and the fifth electrodes 12, 112, and 312 may be provided on the first substrate 23.

(6) The second electrode 22, the deflection electrode 27, and the like may be provided on the first substrate 23, and the first electrode 21, the detection electrodes 26 and 126, and the like may be provided on the second substrates 24 and 124. This configuration may be applied to (5) described above.

(7) Each of the electrodes 11, 111, 211, 311, 12, 112, 312, 21, 22, 26, 126, and 27 may be made of an electroconductive paste, plating, or the like.

(8) It is also possible to use a double-sided tape or the like instead of the spacers 28.

(9) In the second embodiment, the number of the needle-like portion 112B may be two, three, four, or six or more, instead of five.

(10) In the second embodiment, it is also possible to arrange a plurality of fourth electrodes 111 with a distance therebetween in the Y-axis direction. In this case, it is possible to make the number of the fourth electrodes 111 coincide with the number of the needle-like portions 112B and to arrange the needle-like portions 112B and the fourth electrodes 111 on the same straight lines extending in the X-axis direction. However, this is not a limitation.

(11) In the second embodiment, the fifth electrode 112 may have a plurality of the trunk portions 112A. The number of the trunk portions 112A may coincide with the number of the needle-like portions 112B, and each needle-like portions 112B may be independently continuous with a corresponding one of the trunk portions 112A. However, this is not a limitation.

(12) In the third embodiment, the distance between the needle-like portion 212B and the end portion of the fourth electrode 211 on the upstream side need not be uniform. Also in this case, in comparison with the first embodiment, the distance between the needle-like portion 212B and the end portion of the fourth electrode 211 on the upstream side changes by a smaller amount in accordance with a position in a direction that is along the end portion of the fourth electrode 211 on the upstream side, and therefore it is possible to stably generate corona discharge.

(13) In the fourth embodiment, the number of the electrode sets 13 may be two, or four or more.

(14) It is also possible to arrange each of a plurality of detection electrodes 26 and 126 and a plurality of deflection electrodes 27 with a distance therebetween in the Y-axis direction.

(15) Both of the dispersion voltage DV and the compensation voltage CV may be applied to the second electrode 22. In this case, the first electrode 21 may be, for example, grounded.

(16) It is also possible to apply the compensation voltage CV to the first electrode 21 and to apply the dispersion voltage DV to the second electrode 22.

(17) An analyzer according to an embodiment may use an analysis method other than FAIMS.

The present disclosure contains subject matter related to that disclosed in Japanese Priority Patent Application JP 2022-211324 filed in the Japan Patent Office on Dec. 28, 2022, the entire contents of which are hereby incorporated by reference.

It should be understood by those skilled in the art that various modifications, combinations, sub-combinations, and alterations may occur depending on design requirements and other factors insofar as they are within the scope of the appended claims or the equivalents thereof.

What is claimed is:

1. A detector comprising:
a first substrate having a first main surface;
a second substrate having a second main surface that faces the first main surface of the first substrate with a gap therebetween;
a first electrode that is provided on the first main surface of the first substrate;
a second electrode that is provided on the second main surface of the second substrate, that faces the first electrode with a gap therebetween, and that forms a flow path for charged particles, which are to be detected, between the second electrode and the first electrode;
a third electrode that is provided on the first main surface of the first substrate or the second main surface of the second substrate, that is disposed on a downstream side of the flow path relative to the first electrode or the second electrode, and that collects the charged particles;
a fourth electrode that is provided on the first main surface of the first substrate and that is disposed on an upstream side of the flow path relative to the first electrode; and
a fifth electrode that is provided on the second main surface of the second substrate, that is disposed on the upstream side of the flow path relative to the second electrode, and that generates corona discharge between the fifth electrode and the fourth electrode,
wherein the fourth electrode and the fifth electrode are disposed to be displaced relative to each other on the upstream side and the downstream side of the flow path.

2. The detector according to claim 1, wherein the fourth electrode and the fifth electrode are disposed with a distance therebetween on the upstream side and the downstream side of the flow path.

3. The detector according to claim 1, wherein one electrode among the fourth electrode and the fifth electrode includes a needle-like portion whose width decreases toward the other electrode among the fourth electrode and the fifth electrode in a first direction that is along the flow path.

4. The detector according to claim 3,
wherein a radius of curvature of the needle-like portion is in a range of 30 μm to 200 μm, and
wherein a distance between the one electrode and the other electrode is in a range of 1.5 mm to 10 mm.

5. The detector according to claim 3,
wherein the one electrode includes a plurality of the needle-like portions, and
wherein the plurality of needle-like portions are arranged with a distance therebetween in a second direction that is along the first main surface or the second main surface and that intersects the first direction.

6. The detector according to claim 5,
wherein the one electrode includes a trunk portion that extends in the second direction and with which the plurality of needle-like portions are continuous, and
wherein the other electrode extends linearly in the second direction.

7. The detector according to claim 3, wherein the other electrode has an arc shape, and a center of curvature the other electrode is positioned on the needle-like portion side in the first direction.

8. The detector according to claim 1, wherein one of the fourth electrode and the fifth electrode that is disposed on the upstream side of the flow path is a positive electrode, and the other of the fourth electrode and the fifth electrode that is disposed on the downstream side of the flow path is a negative electrode.

9. The detector according to claim 8, wherein a plurality of electrode sets each of which is composed of the fourth electrode and the fifth electrode are disposed at positions that are separated with a distance therebetween in a first direction that is along the flow path.
